(19) United States
(12) Patent Application Publication
(10) Pub. No.: US 2019/0302370 A1
(43) Pub. Date: Oct. 3, 2019

(54) OPTICAL MODULE

(71) Applicant: FUJITSU COMPONENT LIMITED, Tokyo (JP)

(72) Inventor: Takashi Sugata, Tokyo (JP)

(21) Appl. No.: 16/299,576

(22) Filed: Mar. 12, 2019

(30) Foreign Application Priority Data
Mar. 27, 2018 (JP) 2018-060217

(51) Int. Cl. G02B 6/32; G02B 1/10; G02B 6/42; G01J 1/04

(52) U.S. Cl. CPC G02B 6/32; G02B 1/10; G02B 6/4212; G01J 1/0411; G02B 6/4214

(57) ABSTRACT

An optical module includes a lens sheet having a plurality of lenses, an optical waveguide having a plurality of cores through which light propagates, and an ultraviolet curable resin configured to bond the lens sheet and the optical waveguide to each other, wherein the lens sheet has at least one lens-disposed area in which the lenses are formed, the lens-disposed area having a higher ultraviolet-light transmissivity than a low transmissivity area of the lens sheet, the low transmissivity area being situated around the lens-disposed area.

### BACKGROUND OF THE INVENTION

### 1. Field of the Invention

The disclosures herein relate to an optical module.

### 2. Description of the Related Art

A QSFP (Quad Small Form-factor Pluggable) optical module used for QSFP, which is an interface standard for optical communication, has an embedded optical module in which light emitting devices and light receiving devices are mounted on an optical waveguide. In order to make such an optical module, a lens sheet, an optical waveguide, and a flexible substrate are bonded together through adhesive sheets. Gaps between the components are then filled with an ultraviolet curable resin or the like to secure the surroundings of the adhesive sheets.

Ultraviolet curable resin is used when bonding the lens sheet to the optical waveguide. Because an ultraviolet curable resin exhibits cure shrinkage upon curing, a positional displacement may occur between the lenses of the lens sheet and the cores of the optical waveguide. Such a positional displacement causes an increase in optical loss, which results in a drop in performance and/or a drop in yield.

Accordingly, there may be a need for an optical module that is free from a positional displacement between the lenses and the cores upon bonding the lens sheet and the optical waveguide through an ultraviolet curable resin.

### RELATED-ART DOCUMENTS

### Patent Document

[Patent Document 1] Japanese Patent Application Publication No. 2005-298638

### SUMMARY OF THE INVENTION

It is a general object of the present invention to provide an optical module that substantially obviates one or more problems caused by the limitations and disadvantages of the related art.

According to an embodiment, an optical module includes a lens sheet having a plurality of lenses, an optical waveguide having a plurality of cores through which light propagates, and an ultraviolet curable resin configured to bond the lens sheet and the optical waveguide to each other, wherein the lens sheet has at least one lens-disposed area in which the lenses are formed, the lens-disposed area having a higher ultraviolet-light transmissivity than a low transmissivity area of the lens sheet, the low transmissivity area being situated around the lens-disposed area.

According to an optical module of at least one embodiment, a positional displacement between the lenses of a lens sheet and the cores of an optical waveguide is reduced when bonding the lens sheet and the optical waveguide through an ultraviolet curable resin.

### BRIEF DESCRIPTION OF THE DRAWINGS

Other objects and further features of the present invention will be apparent from the following detailed description when read in conjunction with the accompanying drawings, in which:

FIG. 1 is a drawing illustrating the structure of an optical module;

FIGS. 2A and 2B are drawings illustrating positional displacement of lenses caused by the cure shrinkage of ultraviolet curable resin;

FIG. 3 is a drawing illustrating positional displacement of lenses caused by the cure shrinkage of ultraviolet curable resin;

FIGS. 4A and 4B are drawings illustrating a lens sheet according to a first embodiment;

FIG. 5 is a drawing illustrating a method of making the optical module of the first embodiment;

FIG. 6 is a drawing illustrating the method of making the optical module of the first embodiment;

FIG. 7 is a drawing illustrating the method of making the optical module of the first embodiment;

FIG. 8 is a drawing illustrating the method of making the optical module of the first embodiment;

FIG. 9 is a drawing illustrating a first variation of the lens sheet according to the first embodiment;

FIG. 10 is a drawing illustrating a second variation of the lens sheet according to the first embodiment;

FIG. 11 is a drawing illustrating a lens sheet according to a second embodiment;

FIG. 12 is a drawing illustrating a method of making the optical module of the second embodiment;

FIG. 13 is a drawing illustrating the method of making the optical module of the second embodiment;

FIG. 14 is a drawing illustrating a method of making the optical module of the second embodiment;

FIG. 15 is a drawing illustrating a lens sheet according to a third embodiment;

FIG. 16 is a drawing illustrating a method of making the optical module of the third embodiment;

FIG. 17 is a drawing illustrating the method of making the optical module of the third embodiment;

FIG. 18 is a drawing illustrating a method of making the optical module of the third embodiment; and

FIGS. 19A and 19B are drawings illustrating deformation of a lens sheet.

### DESCRIPTION OF THE PREFERRED EMBODIMENTS

In the following, embodiments for implementing the invention will be described. The same members or the like are referred to by the same numerals, and a description thereof will be omitted.

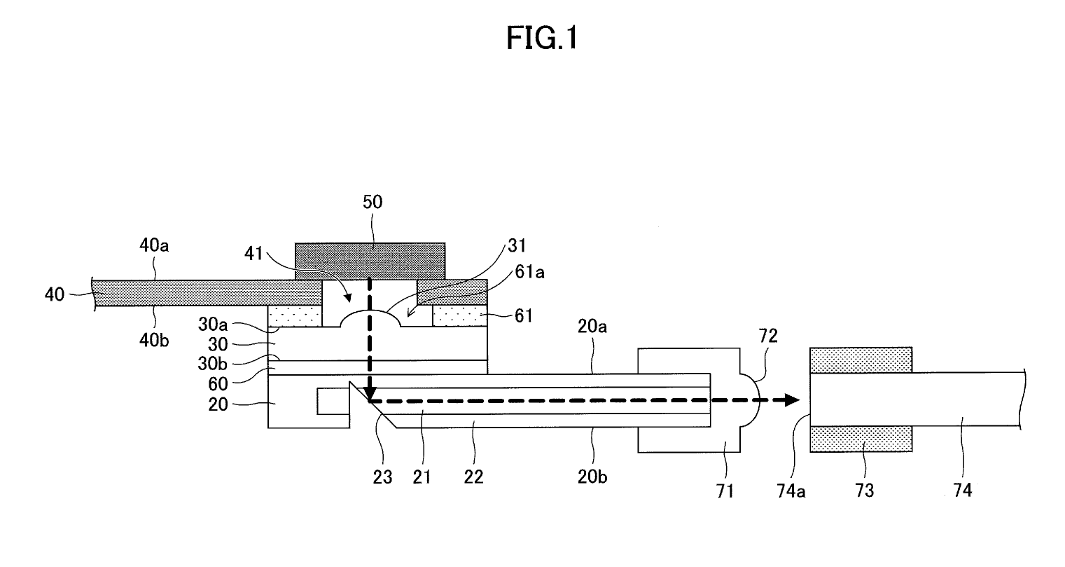

An optical module illustrated in FIG. 1 is configured such that a lens sheet 30 and a flexible substrate 40 are stacked one over another on a sheet-shaped optical waveguide 20.

The optical waveguide 20 is made of a resin such as polyimide. Cores 21 through which light propagates are covered with a cladding 22. A ferrule 71 having lenses is formed at one end of the optical waveguide 20, and a face of a cut made into the optical waveguide 20 serving as a mirror 23 is formed at another end.

Lenses 31 are formed on a face 30a of the lens sheet 30. On a face 40a of the flexible substrate 40, light emitting devices 50 and light receiving devices (not shown) are mounted. The flexible substrate 40 has a penetrating hole 41 at the position of the path of light emitted from the light emitting devices 50 and entering the light receiving devices. An adhesive sheet 61 also has a penetrating hole 61a at the position of the path of light. The lens sheet 30 and the flexible substrate are bonded to each other through the adhesive sheet 61. The optical waveguide 20 and the lens sheet 30 are bonded to each other through an ultraviolet curable resin 60.

In the optical module of the present embodiment, light emitted by the light emitting devices 50 such as VCSELs (vertical cavity surface emitting lasers) passes through the hole 41 to enter the lenses 31 to be concentrated. Light concentrated by the lenses 31 passes through the lens sheet 30 and the resin 60 to enter the optical waveguide 20, being reflected at the mirror 23 and then propagating through the cores 21. Light propagating through the cores 21 exits through the lenses 72 to enter optical fibers 74 coupled to a ferrule 73 to propagate through the optical fibers 74.

The light receiving devices (not shown) receive light having propagated through the optical fibers 74. Light having propagated through the optical fibers 74 exits through an end 74a to enter the cores 21 through the lenses 72 and propagate through the cores 21. Light having propagated through the cores 21 are reflected by the mirror 23 to pass through the resin 60, and is concentrated by the lenses 31 to enter the light receiving devices.

The lens sheet 30 and the resin 60 are made of a material allowing the passage of light. In particular, the resin 60 is implemented as a curable resin specifically made for optical use. As is known, the resin 60 experiences cure shrinkage upon curing. The cure shrinkage rate of an ultraviolet curable resin for optical use is as high as approximately 10%.

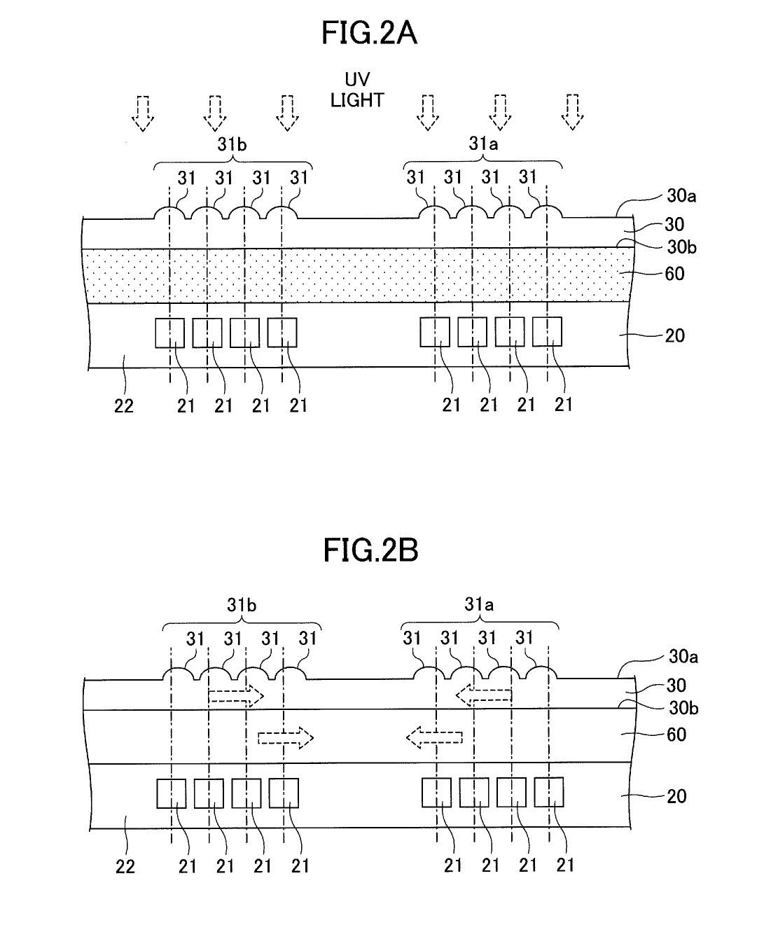

When bonding the optical waveguide 20 and the lens sheet 30, the optical waveguide 20 and the lens sheet 30 are aligned with each other as illustrated in FIG. 2A, and, then, the resin 60 is poured into the gap between the optical waveguide 20 and the lens sheet 30. The resin 60 needs to be injected into the gap, and thinly spread over a wide area, between the optical waveguide 20 and the lens sheet 30, which is thin and soft. Subsequently, the resin 60 is irradiated with ultraviolet light to cure the resin 60, thereby bonding the optical waveguide 20 and the lens sheet 30. Since the lens sheet 30 is extremely thin and easy to be deformed, and the resin 60 is spread over a wide area, the cure shrinkage of the resin 60 acts to pull a lens group 31a and a lens group 31b toward the center as illustrated in FIG. 2B. As a result, a positional displacement occurs between the centers of the cores 21 shown in dot-and-dash lines and the centers of the lenses 31.

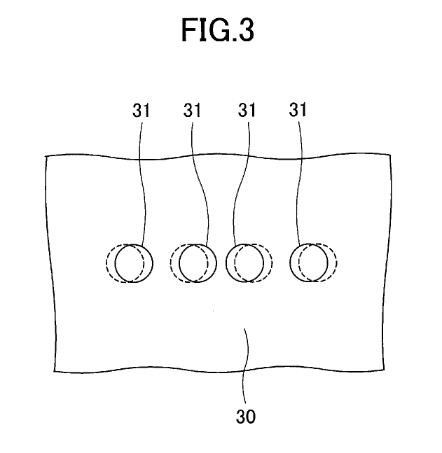

Each of the lens group 31a and the lens group 31b has four lenses 31. The cure shrinkage of the resin 60 may pull the lenses 31 toward the center of a given lens group as illustrated in FIG. 3. In FIG. 3, dashed lines indicate the positions of the lenses 31 before the curing of the resin 60, and the solid lines indicate the positions of the lenses 31 after the curing of the resin 60.

A positional displacement between the cores 21 and the lenses 31 increases optical loss between the lenses 31 and the cores 21, which results in reduction in performance and a drop in yield. The diameter of the lenses 31 is 100 micrometers to 200 micrometers. Optical loss occurs when the centers of the lenses 31 move 10 micrometers or more. The positional displacement of the lenses 31 is thus preferably smaller than or equal to 5 micrometers. In the noted configuration, the thickness of the lens sheet 30 is approximately 100 micrometers, and the thickness of the optical waveguide 20 is approximately 100 micrometers, with the thickness of the resin 60 being approximately 30 micrometers.

When bonding the lens sheet 30 through the resin 60, the resin 60 may be thinly spread over a surface 30b of the lens sheet 30 to avoid optical loss at the space between the lens sheet 30 and the resin 60. In such a case also, the cure shrinkage of the widely applied resin 60 has a further noticeable effect to cause deformation in the thin, soft lens sheet 30, thereby further increasing the positional displacement of the lenses 31.

### <Optical Module>

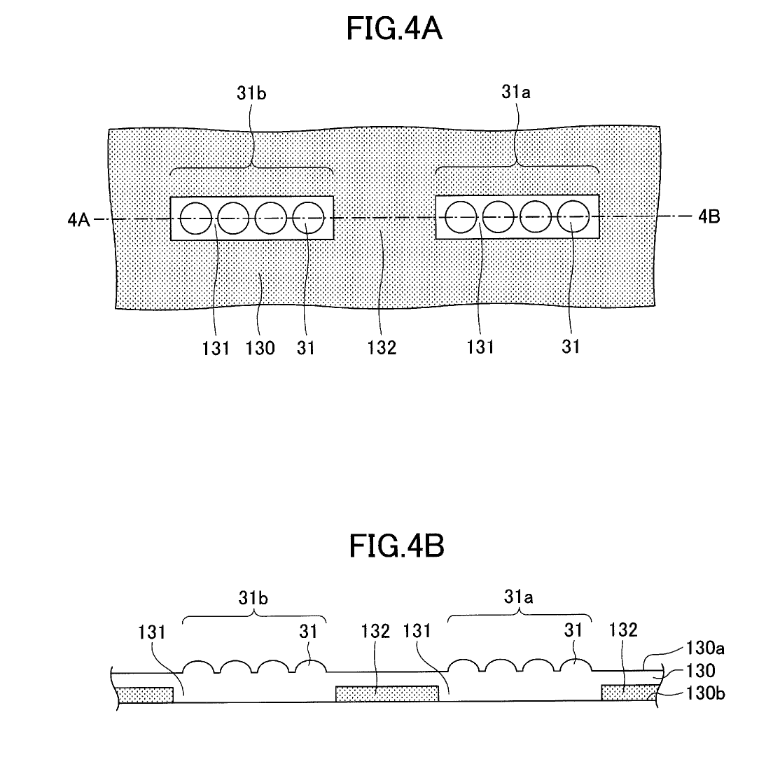

In the following, an optical module of the first embodiment will be described. FIG. 4A is a top view of a lens sheet 130 according to a present embodiment. FIG. 4B is a cross-sectional view taken along the line 4A-4B illustrated in FIG. 4A.

As illustrated in FIGS. 4A and 4B, the lens sheet 130 has a first region 131 having a high transmissivity with respect to ultraviolet light and a second region 132 whose ultraviolet light transmissivity is smaller than that of the first region 131. The lenses 31 are formed on the surface 130a. A lens-disposed area having the lenses 31 is positioned in the first region 131. The second region 132 is formed around the first region 131. The lens sheet 130 is made of a material allowing light to pass through, such as polycarbonate. The second region 132 contains a material that absorbs ultraviolet light. In the present embodiment, the ultraviolet light transmissivity of the first region 131 is 85% or more, and the ultraviolet light transmissivity of the second region 132 is greater than or equal to 40% and less than or equal to 60%.

The lens sheet 130 includes a lens group 31a for light reception and a lens group 31b for light transmission as illustrated in FIGS. 4A and 4B. The lens group 31a includes four lenses 31 aligned in one line, and the lens group 31b has four lenses aligned in one line. The lens-dispose areas having the lens group 31a and the lens group 31b are formed as the first region 131 because light is supposed to pass through these areas. The second region 132 is disposed between the first region 131 having the lens group 31a and the first region 131 having the lens group 31b.

### <Method of Making Optical Module>

In the following, a method of making an optical module according to the present embodiment will be described with reference to FIG. 5 through FIG. 8. A mercury lamp or the like may be used to radiate ultraviolet light, and a total amount of ultraviolet radiation power may be 2000 mJ to 4000 mJ, for example.

In order to make the optical module of the present embodiment, the cores 21 are aligned with the lenses 31 corresponding to the respective cores, as illustrated in FIG. 5. The optical waveguide 20 and the lens sheet 130 are then tentatively fixed in their positions by use of adhesive sheets (not shown) or the like.

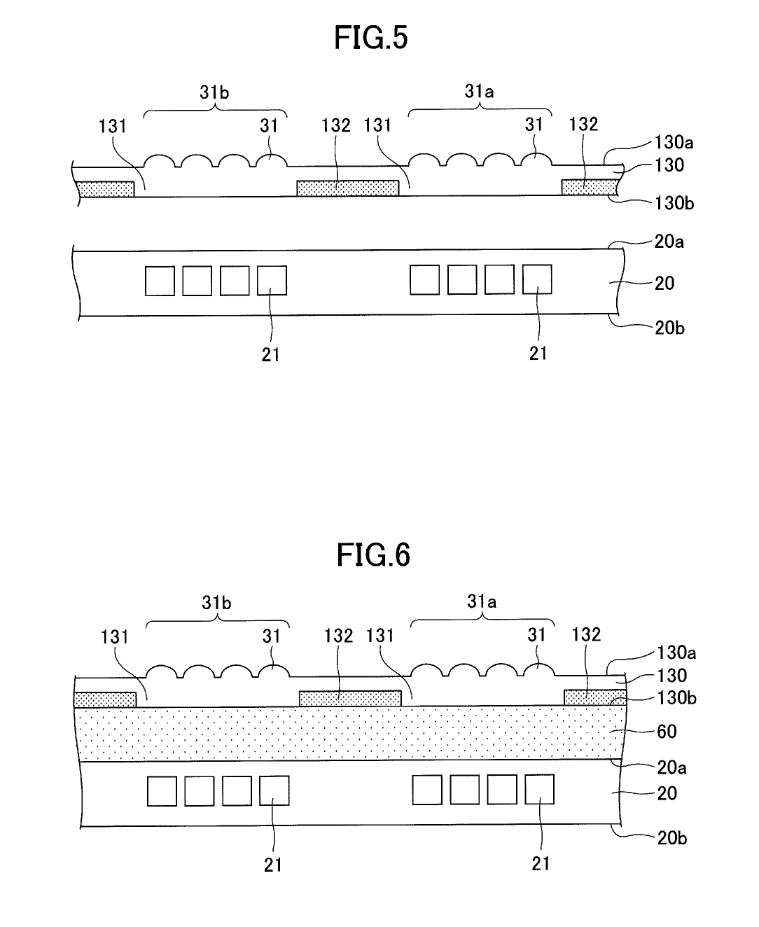

As illustrated in FIG. 6, the resin 60 is poured into the gap between the optical waveguide 20 and the lens sheet 130. The resin 60, which has fluidity, spreads in the space between the optical waveguide 20 and the lens sheet 130.

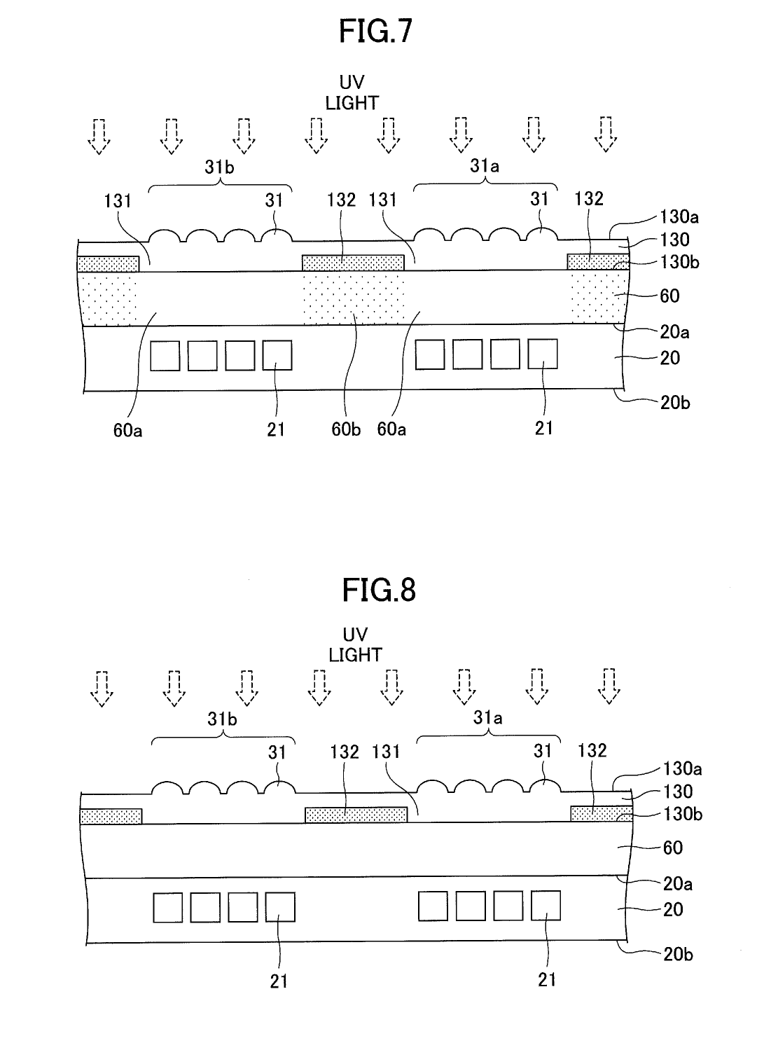

Radiating ultraviolet light from above the lens sheet 130 causes an ultraviolet curable resin 60a directly below the first region 131 to cure first as illustrated in FIG. 7. With this arrangement, the positional displacements of the lenses 31 in the first region 131 are substantially small. In that state, an ultraviolet curable resin 60b situated directly below the second region 132 is not yet cured.

Continuing radiation of causes the resin 60b below the second region 132 to be gradually cured, resulting in the curing of the entirety of the resin 60 as illustrated in FIG. 8. FIG. 8 is a cross-sectional view of the optical module according to the present embodiment. As illustrated in FIG. 8, the optical module has the optical waveguide 20 and the lens sheet 30 bonded together through the resin 60.

The amount of light with which the resin 60 is irradiated is lower with respect to the second region 132 than with respect to the first region 131, so that the speed at which the resin 60 cures is slower with respect to the second region 132. As a result, the resin 60a directly below the first region 131 cures first, and, then, the resin 60b directly below the second region 132 cures next.

In the present embodiment, the resin 60a situated directly below the first region 131, which has the lenses 31 for which a positional displacement most needs to be prevented, is cured first so as to solidify the area of this resin portion. Locally curing the resin 60a serves to reduce an effect of the cure shrinkage of the resin 60 on the lens sheet 130 to a minimum level, thereby reducing positional displacement of the lenses 31. After the curing of the areas where the lenses 31 are provided, the cure shrinkage of the resin 60b situated directly below the surrounding second region 132 does not cause positional displacement of the lenses 31 because the resin 60 under the first region 131 has been already cured and solidified.

<Other Lens Sheet>

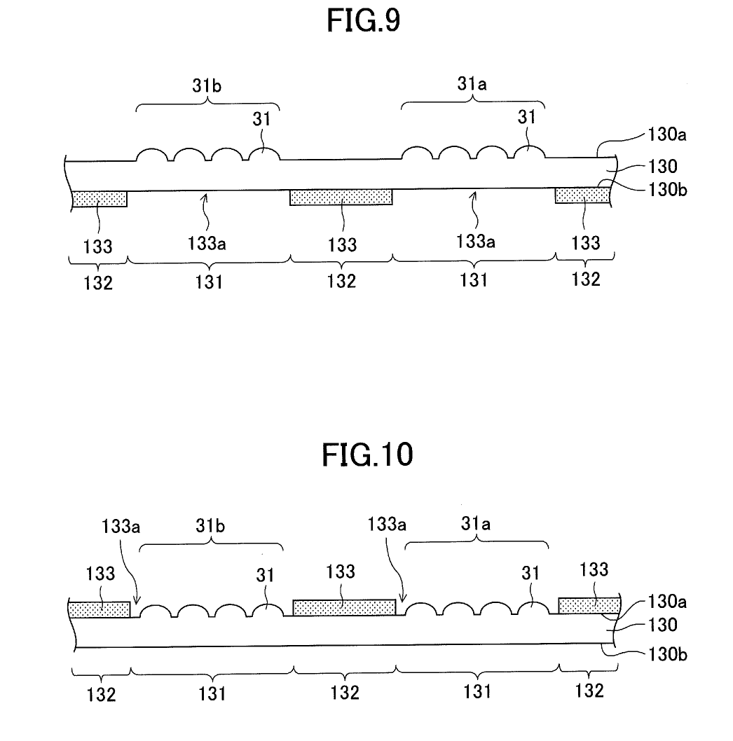

In the present embodiment, the surface 130b may be bonded to a light absorption layer 133 to form the second region 132 as illustrated in FIG. 9. Alternatively, the surface 130a may be bonded to the light absorption layer 133 to form the second region 132 as illustrated in FIG. 10. In these cases, openings 133a of the light absorption layer 133 correspond to the first regions 131.

The light absorption layer 133 for forming the second region 132 may be made by applying a resin material containing a light absorbing material.

### Second Embodiment

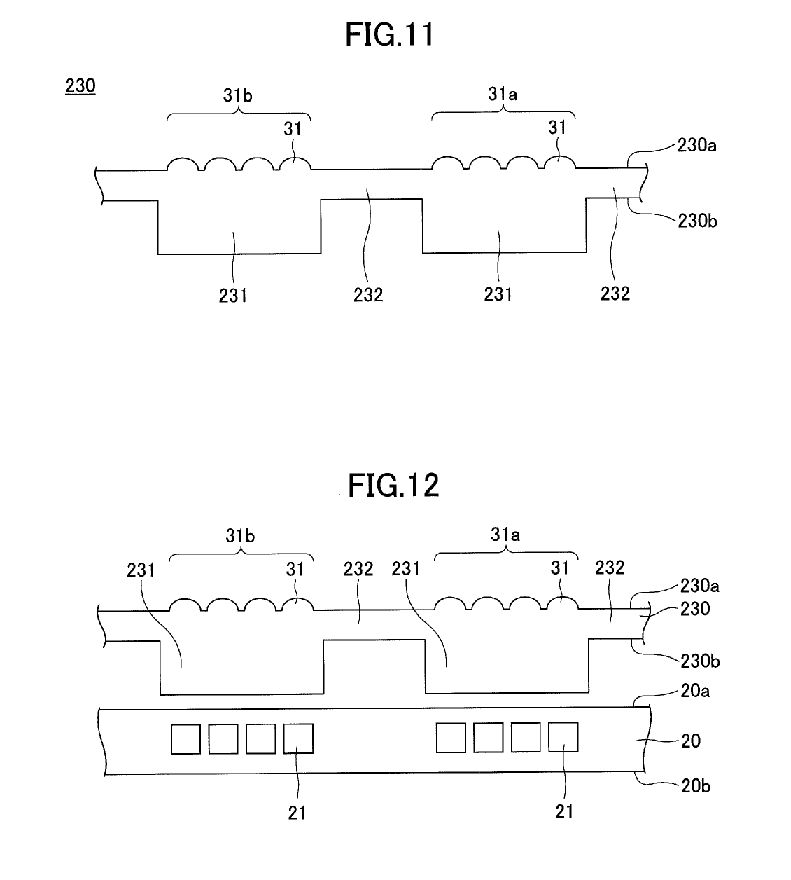

In the second embodiment, the lenses 31 are formed on a surface 230a of a lens sheet 230 as illustrated in FIG. 11. The lens-disposed areas of the lens sheet 230 are thick areas 231 being thicker than other areas. The areas of the lens sheet 230 other than the lens-disposed areas are thin areas 232 thinner than the thick areas 231. One thin area 232 is situated between the thick area 231 in which the lens group 31a are formed and the thick area 231 in which the lens group 31b are formed.

### <Method of Making Optical Module>

In the following, a method of making an optical module according to the present embodiment will be described with reference to FIG. 12 through FIG. 14.

In order to make the optical module of the present embodiment, the cores 21 and the lenses 31 are aligned with each other as illustrated in FIG. 12, and, then, the optical waveguide 20 and the lens sheet 230 are tentatively fixed in their positions.

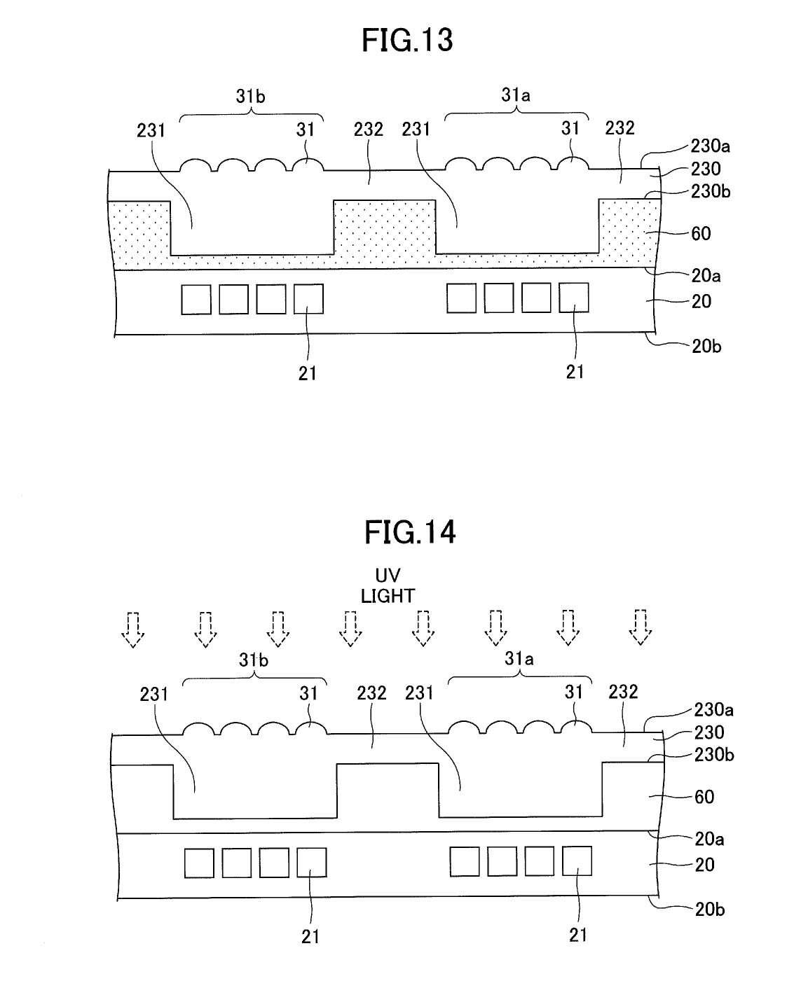

As illustrated in FIG. 13, the resin 60 is poured into the gap between the optical waveguide 20 and the lens sheet 230.

By irradiating ultraviolet light from above the lens sheet 230, the resin 60 cures as illustrated in FIG. 14. The thick areas 231 have high strength, and are thus not readily affected by the cure shrinkage of the resin 60, which results in a reduced positional displacement of the lenses 31. Positional displacement of the lenses 31 that could occur as illustrated in FIG. 3 is thus reduced.

Moreover, as the resin 60 is thin at the positions of the thick areas 231, cure shrinkage of the resin 60 is reduced. Thus, deformation of the lens sheet 230 and positional displacement of the lenses 31 caused by the cure shrinkage of the resin are reduced in such areas. As described above, the thickness of the resin 60 at the position at which an effect of the cure shrinkage of the resin needs to be reduced is made thinner than the surrounding areas, which serves to reduce the deformation and positional displacement of an optical component caused by the cure shrinkage of the resin 60.

Configurations other than those described above are the same as or similar to those of the first embodiment.

### Third Embodiment

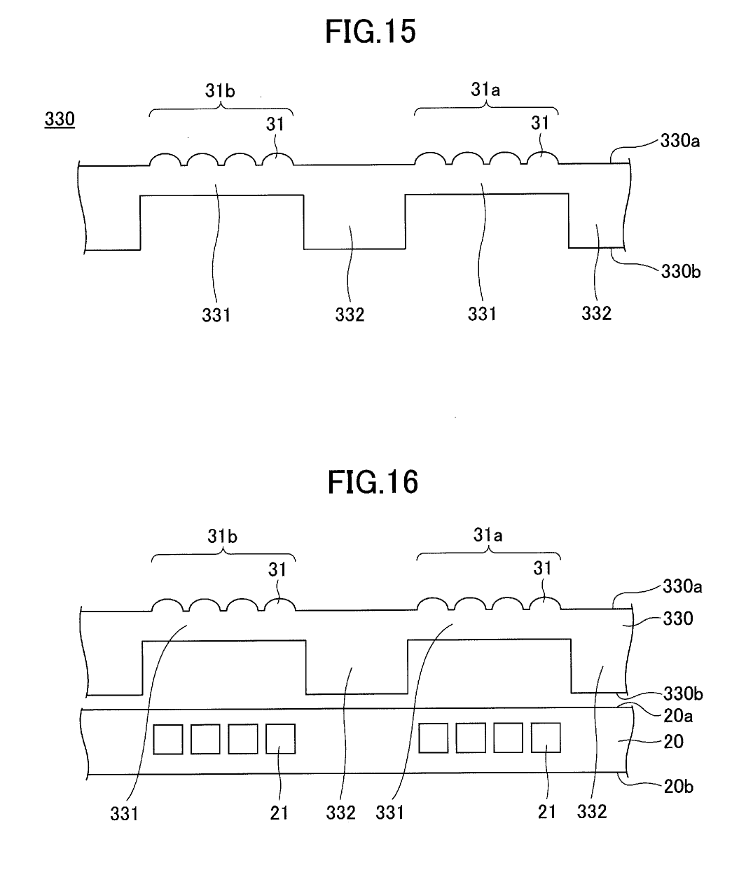

In the third embodiment, the lenses 31 are formed on a surface 330a of a lens sheet 330 as illustrated in FIG. 15. The lens-disposed areas of lens sheet 330 in which the lenses 31 are formed are thin areas 331 being thinner than the other areas of the lens sheet 330, which are thick areas 332. One thick area 332 is situated between the thin area 331 in which the lens group 31a are formed and the thin area 331 in which the lens group 31b are formed.

### <Method of Making Optical Module>

In the following, a method of making an optical module according to the present embodiment will be described with reference to FIG. 16 through FIG. 18.

When making the optical module, the cores 21 and the lenses 31 are aligned with each other as illustrated in FIG. 16, and, then, the optical waveguide 20 and the lens sheet 330 are tentatively fixed in their positions.

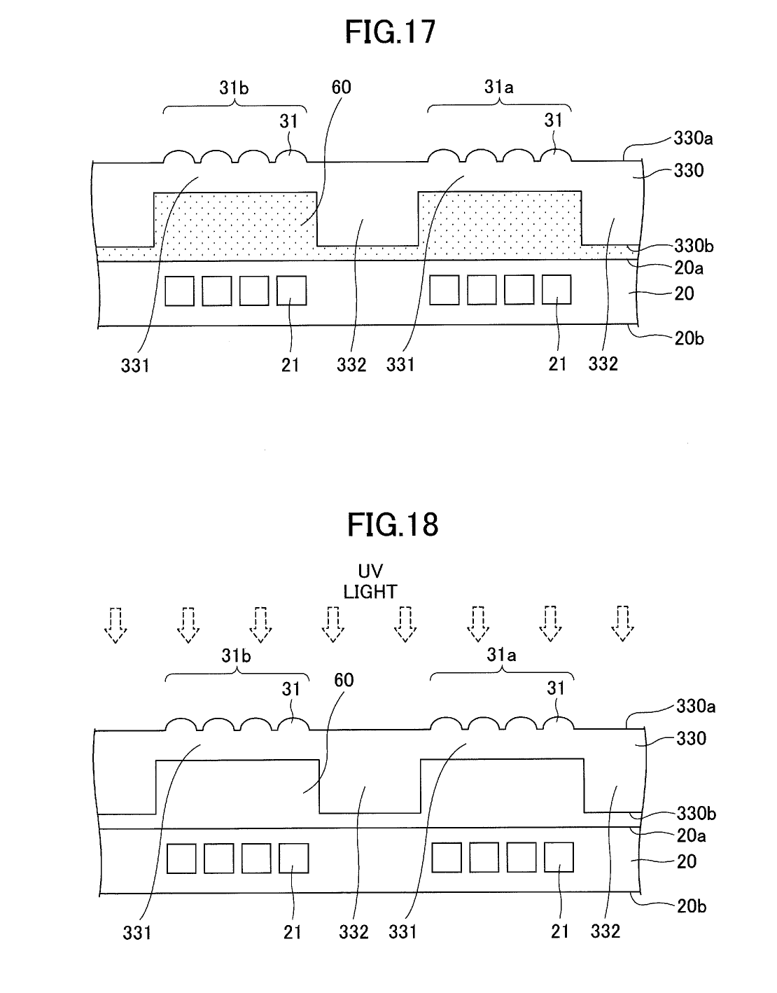

As illustrated in FIG. 17, the resin 60 is poured into the gap between the optical waveguide 20 and the lens sheet 330.

Irradiating ultraviolet light from above the lens sheet 330 causes the resin 60 to cure as illustrated in FIG. 18. The thick area 332 situated between the two lens-disposed areas has high strength, and is thus not readily affected by the cure shrinkage of the resin 60, which results in a reduced positional displacement of the lenses 31. Positional displacement of the lenses 31 that could occur as illustrated in FIG. 2 is thus reduced.

Moreover, the resin 60 cures and shrinks mostly toward the center of the lenses 31, so that the cure shrinkage of the resin 60 in the surrounding areas of the lenses 31 does not readily pull the lenses 31, which results in the positional displacement of the lenses 31 being reduced. As described above, the thickness of the resin 60 at the position at which an effect of the cure shrinkage of the resin 60 needs to be reduced is made thicker than the surrounding areas. An optical component at such a position, at which an effect of the cure shrinkage of the resin 60 needs to be reduced, experiences a reduced positional displacement caused by being pulled by the cure shrinkage of the resin 60 existing in the surrounding areas. The positional displacement of the optical component is thus reduced.

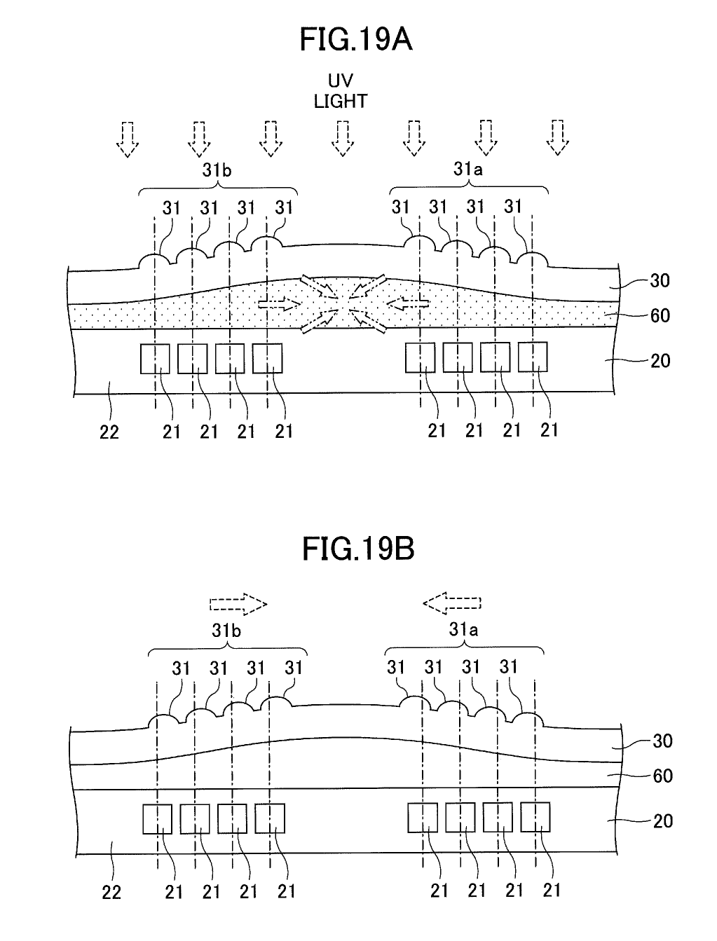

When the lens sheet 30 is thin as illustrated in FIG. 19A, injecting the resin 60 into the gap between the lens sheet 30 and the optical waveguide 20 may cause the lens sheet 30 to deform and bulge upwardly at the center. As the resin 60 is cured in such a state, the deformed lens sheet 30 is bonded to the optical waveguide 20 as illustrated in FIG. 19B. In the present embodiment, the thick area 332 disposed between the lens group 31a and the lens group 31b is thick and of high strength, and is thus not deformable. In FIG. 19A, dash-and-dot arrows illustrated in the resin 60 indicate pulling forces generated by the cure shrinkage of the resin 60. Even though the thin areas 331 may also bulge outwardly at the centers, there is a large amount of the resin 60 in these areas, and an effect of the cure shrinkage of the resin 60 is strong, which reduces deformation of the thin areas 331.

Configurations and features other than those described above are the same as or similar to those of the first embodiment.

Further, although a description has been given with respect to one or more embodiments of the present invention, the contents of such a description do not limit the scope of the invention.

The present application is based on and claims priority to Japanese patent application No. 2018-060217 filed on Mar. 27, 2018, with the Japanese Patent Office, the entire contents of which are hereby incorporated by reference.

What is claimed is:

1. An optical module, comprising:
a lens sheet having a plurality of lenses;
an optical waveguide having a plurality of cores through which light propagates; and
an ultraviolet curable resin configured to bond the lens sheet and the optical waveguide to each other,
wherein the lens sheet has at least one lens-disposed area in which the lenses are formed, the lens-disposed area having a higher ultraviolet-light transmissivity than a low transmissivity area of the lens sheet, the low transmissivity area being situated around the lens-disposed area.

2. The optical module as claimed in claim 1, wherein the lenses include a first lens group having a plurality of lenses and a second lens group having a plurality of lenses, and at least a part of the low transmissivity area is disposed between the lens-disposed area corresponding to the first lens group and the lens-disposed area corresponding to the second lens group.

3. An optical module, comprising:
a lens sheet having a plurality of lenses;
an optical waveguide having a plurality of cores through which light propagates; and
an ultraviolet curable resin configured to bond the lens sheet and the optical waveguide to each other,
wherein the lens sheet has at least one lens-disposed area in which the lenses are formed, a thickness of the lens-disposed area being different from a thickness of an area situated around the lens-disposed area.

4. The optical module as claimed in claim 3, wherein the thickness of the lens-disposed area is thicker than the thickness of the area situated around the lens-disposed area.

5. The optical module as claimed in claim 3, wherein the thickness of the lens-disposed area is thinner than the thickness of the area situated around the lens-disposed area.
